(19) United States
(12) Patent Application Publication
(10) Pub. No.: US 2026/0245369 A1
(43) Pub. Date: Aug. 20, 2026

(54) DETECTION DEVICE, DETECTION METHOD, AND NON-TRANSITORY COMPUTER-READABLE MEDIUM

(71) Applicant: NEC Corporation, Tokyo (JP)

(72) Inventors: Yaeko YONEZAWA, Tokyo (JP); Syunsuke YAMAMOTO, Tokyo (JP); Yuji TAHARA, Tokyo (JP)

(73) Assignee: NEC Corporation, Tokyo (JP)

(21) Appl. No.: 19/165,668

(22) PCT Filed: Mar. 28, 2023
(86) PCT No.: PCT/JP2023/012479

§ 371 Date: Sep. 16, 2025

(51) Int. Cl. G06V 20/52; G06V 10/25; G06V 10/72

(52) U.S. Cl. CPC G06V 20/52; G06V 10/25; G06V 10/72

(57) ABSTRACT

In a detection device, a detection unit detects a second image region in a captured image by applying a second model to the captured image. A determination unit determines, based on the heights of shelf-image regions and an average value of the height of the second image region in each shelf-image region, an image region to be processed from among the plurality of shelf-image regions. The detection unit applies a first model to the image region to be processed, thereby detecting a first image region in the image region to be processed. The second model is a model for discerning the second image region corresponding to an image of an article group arranged at the front side in a target image. The first model is a model for discerning the first image region based on the space primarily occupied by the articles in the target image.

### TECHNICAL FIELD

The present disclosure relates to a detection device, a detection method, and a non-transitory computer-readable medium.

### BACKGROUND ART

There has been proposed a technology for detecting a region in which an article group continuously exists in an image of the article group such as commodities using one trained identification model (for example, PTL 1).

### CITATION LIST

### Patent Literature

### PTL 1: JP 2021-117531 A

### SUMMARY OF INVENTION

### Technical Problem

The present inventor has found that there is a possibility that the detection accuracy of an image region cannot be sufficiently obtained using one identification model. That is, the identification model usually has detection targets with high detection performance and detection targets with low detection performance. Therefore, the present inventor has found that the detection accuracy of the image region can be improved by applying a first model and a second model having different characteristics to the image of the article group.

An object of the present disclosure is to provide a detection device, a detection method, and a non-transitory computer-readable medium capable of improving the detection accuracy of the image region. The object is merely one of a plurality of objects to be achieved by a plurality of example embodiments disclosed herein. The other objects or problems and novel features will be apparent from the description of the present specification or the accompanying drawings.

### Solution to Problem

According to an aspect of the present disclosure, there is provided a detection device including:
a first detection unit that detects a second image region in a captured image in which an article shelf is imaged by using a second model among a first model that identifies a first image region based on a space primarily occupied by an article group in a target image and the second model that identifies a second image region relevant to an image of an article group arranged on a front side in a target image;
a specification unit that specifies a plurality of shelf-image regions relevant to a plurality of shelf stages of the article shelf in the captured image;
an average value calculation unit that calculates an average value of heights of the second image regions relevant to a height direction of the article shelf in each shelf-image region;
a determination unit that determines an image region to be processed from among the plurality of shelf-image regions based on the average value in each shelf-image region and a height of each shelf-image region; and
a second detection unit that detects the first image region in the image region to be processed by applying the first model to the image region to be processed.

According to another aspect, a detection method includes:
detecting a second image region in a captured image in which an article shelf is imaged by using a second model among a first model that identifies a first image region based on a space primarily occupied by an article group in a target image and the second model that identifies a second image region relevant to an image of an article group arranged on a front side in a target image;
specifying a plurality of shelf-image regions relevant to a plurality of shelf stages of the article shelf in the captured image;
calculating an average value of heights of the second image regions relevant to a height direction of the article shelf in each shelf-image region;
determining an image region to be processed from among the plurality of shelf-image regions based on the average value in each shelf-image region and a height of each shelf-image region; and
detecting the first image region in the image region to be processed by applying the first model to the image region to be processed.

According to still another aspect, a non-transitory computer-readable medium stores a program that causes a detection device to execute:
detecting a second image region in a captured image in which an article shelf is imaged by using a second model among a first model that identifies a first image region based on a space primarily occupied by an article group in a target image and the second model that identifies a second image region relevant to an image of an article group arranged on a front side in a target image;
specifying a plurality of shelf-image regions relevant to a plurality of shelf stages of the article shelf in the captured image;
calculating an average value of heights of the second image regions relevant to a height direction of the article shelf in each shelf-image region;
determining an image region to be processed from among the plurality of shelf-image regions based on the average value in each shelf-image region and a height of each shelf-image region; and
detecting the first image region in the image region to be processed by applying the first model to the image region to be processed.

### Advantageous Effects of Invention

According to the aspects of the present disclosure, it is possible to provide a detection device, a detection method, and a non-transitory computer-readable medium capable of improving the detection accuracy of the image region.

### BRIEF DESCRIPTION OF DRAWINGS

FIG. 1 is a block diagram illustrating an example of a detection device according to a first example embodiment.

FIG. 2 is a flowchart illustrating an example of a processing operation of a detection device according to the first example embodiment.

FIG. 3 is a block diagram illustrating an example of a detection device according to a second example embodiment.

FIG. 4A is a diagram illustrating an example of an article shelf image.

FIG. 4B is a diagram illustrating an example of a second image region.

FIG. 4C is a diagram illustrating an example of a first image region.

FIG. 5 is a block diagram illustrating an example of a detection device according to a third example embodiment.

FIG. 6 is a diagram illustrating an example of an integrated image.

FIG. 7 is a diagram illustrating a hardware configuration example of a detection device.

### EXAMPLE EMBODIMENT

Hereinafter, example embodiments will be described with reference to the drawings. In the example embodiments, the same or equivalent elements are denoted by the same reference numerals, and repeated description will be omitted.

### First Example Embodiment

### Overview of Detection Device

A detection device 10 according to a first example embodiment detects an image region relevant to an image of an article group in a “captured image” by using, for example, a “first model” and a “second model” having different detection characteristics from each other. The “captured image” is, for example, an image (hereinafter, referred to as an “article shelf image”) obtained by imaging an article shelf.

The above-described “second model” is a model that identifies an image region (hereinafter, referred to as a “second image region” or a “second article group image region”) relevant to an image of an article group disposed on the front side in a target image. Hereinafter, the “image of the article group” may be referred to as an “article group image”.

For example, the second model may be a trained model trained using training data including the following images.
An image obtained by imaging the entire one side of a single article.
An article shelf image obtained by designating, as an “article group image region”, an image region relevant to the article group image of an article group arranged in the foremost row of each shelf stage in the article shelf image.

In each article of the article group arranged in the foremost row of the shelf stage, most (for example, a portion occupying more than half of one side) of one side of the article usually appears in the article shelf image.

The training is performed using such training data, and thus the second model can accurately detect the image region relevant to a commodity group located on the front side of each shelf stage. However, there is a possibility that the second model cannot accurately detect the image region relevant to the commodity group that is located behind the commodity group located on the front side and in which most of one sides of the commodities are hidden.

The above-described “first model” is a model that identifies an image region (hereinafter, referred to as a “first image region” or a “first article group image region”) based on a space primarily occupied by the article group in the target image (hereinafter, referred to as an “space primarily occupied by the articles”).

For example, the first model may be a trained model trained using training data including the following images.
An image obtained by imaging the entire one side of a single article.
An article shelf image obtained by designating, as an “article group image region”, an image region relevant to the article group image of an article group arranged in the foremost row of each shelf stage in the article shelf image.
An article shelf image obtained by designating, as a “true background image region”, an image region relevant to an “image relevant to a true background (hereinafter, referred to as a “true background image”)” in the article shelf image.

Here, the “true background image region” includes an image of a back panel, a side panel, or a shelf panel of the article shelf which is shown in the article shelf image without being hidden by the shadow of the articles in the article shelf image.

The training is performed using such training data, and thus the first model has characteristics capable of accurately detecting an image region highly likely to be a background image (for example, an image region relevant to a large empty space in which articles are not arranged) and an image region relevant to the above-described space primarily occupied by the articles. However, since the first model is trained using Conflicting information such as the “article group image region” and the “true background image region”, there is a possibility that a region close to the “article group image region” is detected as the “article group image region” and a region close to the “true background image region” is detected as the “true background image region” for a region that is not designated as both the “article group image region” and the “true background image region”. Therefore, there is a possibility that an image region relevant to a narrow empty space sandwiched between two “article group image regions” is detected as a part of the article group image region. This is because it is considered that there are many cases where sufficient information for detecting that an image is a background image cannot be obtained from an image relevant to the narrow empty space.

Unlike the training data of the first model, the training data of the second model does not include the article shelf image for which the “true background image region” is designated, or has a small number of the article shelf images for which the “true background image region” is designated even when including the article shelf image.

As described above, the detection device 10 detects an image region relevant to an image of an article group in a captured image by using the “first model” and the “second model” having different detection characteristics from each other. Thus, the detection accuracy of the image region can be improved.

### Configuration Example of Detection Device

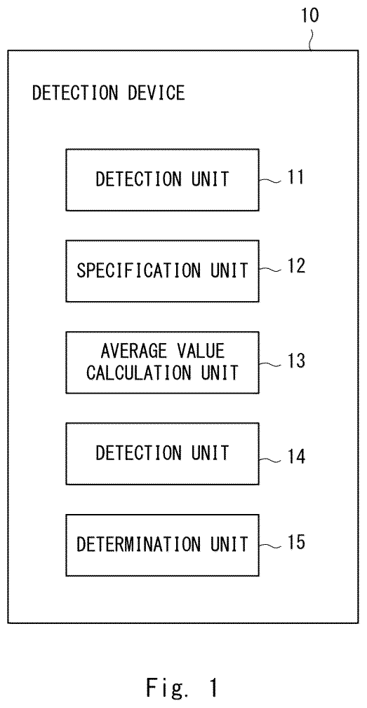

FIG. 1 is a block diagram illustrating an example of a detection device according to the first example embodiment. In FIG. 1, the detection device 10 includes a detection unit (first detection unit) 11, a specification unit 12, an average value calculation unit 13, a detection unit (second detection unit) 14, and a determination unit 15. The detection device 10 acquires a captured image. This captured image is, for example, an article shelf image obtained by imaging an article shelf. The following description will be made assuming that the captured image is the article shelf image. The article shelf has a plurality of shelf stages.

The detection unit 11 detects a second image region in the captured image by applying the second model to the captured image.

The specification unit 12 specifies a plurality of “shelf-image regions” relevant to a plurality of shelf stages in the captured image. A shelf-image region relevant to one shelf stage is, for example, an image region relevant to a space between the shelf panel of one shelf stage and the shelf panel of a shelf stage immediately above the one shelf stage.

The average value calculation unit 13 calculates an average value of the heights of the second image regions in the shelf-image regions. The height of the second image region is a length of the second image region relevant to the height direction of the article shelf.

The determination unit 15 determines, based on the heights of shelf-image regions and an average value of the height of the second image region in each shelf-image region, an image region to be processed by the detection unit 14 from among the plurality of shelf-image regions. The height of the shelf-image region is the length of the shelf-image region relevant to the height direction of the article shelf.

The detection unit 14 applies a first model to the image region to be processed, which has been determined by the determination unit 15, thereby detecting a first image region in the image region to be processed.

### Operation Example of Detection Device

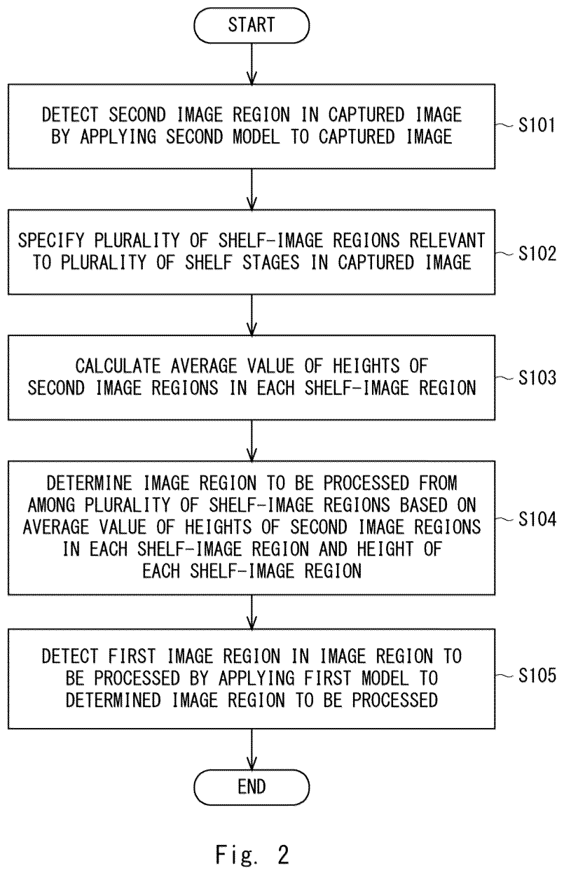

An example of a processing operation of the detection device 10 having the above-described configuration will be described. FIG. 2 is a flowchart illustrating an example of the processing operation of the detection device according to the first example embodiment.

The detection unit 11 detects the second image region in the captured image by applying the second model to the captured image (step S101).

The specification unit 12 specifies a plurality of shelf-image regions relevant to a plurality of shelf stages in the captured image (step S102).

The average value calculation unit 13 calculates an average value of the heights of the second image regions in the shelf-image regions (step S103).

The determination unit 15 determines, based on the heights of shelf-image regions and an average value of the height of the second image region in each shelf-image region, an image region to be processed by the detection unit 14 from among the plurality of shelf-image regions (step S104).

The detection unit 14 applies a first model to the image region to be processed, which has been determined by the determination unit 15, thereby detecting a first image region in the image region to be processed (step S105).

As described above, according to the first example embodiment, the detection device 10 detects an article group image region in the captured image by using the “first model” and the “second model” having different detection characteristics from each other. Thus, since one model can compensate for the low detection performance of the other model in detecting the detection target, the detection accuracy of the article group image region can be improved.

In the detection device 10, the detection unit 11 detects a second image region in a captured image by applying a second model to the captured image. The determination unit 15 determines, based on the heights of shelf-image regions and an average value of the height of the second image region in each shelf-image region, an image region to be processed by the detection unit 14 from among the plurality of shelf-image regions. The detection unit 14 applies a first model to the image region to be processed, which has been determined by the determination unit 15, thereby detecting a first image region in the image region to be processed. The second model is a model for discerning the second image region relevant to an image of an article group arranged at the front side in a target image. The first model is a model for discerning the first image region based on the space primarily occupied by the articles in the target image.

With the configuration of the detection device 10, the detection accuracy of the article group image region can be improved. That is, for example, in a case where the average value of the heights of the second image regions in the shelf-image region is sufficiently smaller than the height of the shelf-image region, there is a high possibility that the article located backward is also imaged in the shelf-image region. In a case where the second model is applied to such a shelf-image region, there is a possibility that an image region relevant to the articles located backward cannot be accurately detected. On the other hand, in a case where the first model is applied to such a shelf-image region, there is a high possibility that an image region relevant to the articles located backward can be accurately detected. On the other hand, in a case where the average value of the heights of the second image regions in the shelf-image region is sufficiently larger than the height of the shelf-image region, there is a high possibility that the article positioned backward is hardly captured in the shelf-image region. In a case where the second model is applied to such a shelf-image region, there is a high possibility that an image region relevant to the commodity group located on the front side can be accurately detected. Therefore, since one model can compensate for the low detection performance of the other model in detecting the detection target, the detection accuracy of the article group image region can be improved.

### Second Example Embodiment

A second example embodiment relates to an example embodiment that describes the first example embodiment in more detail.

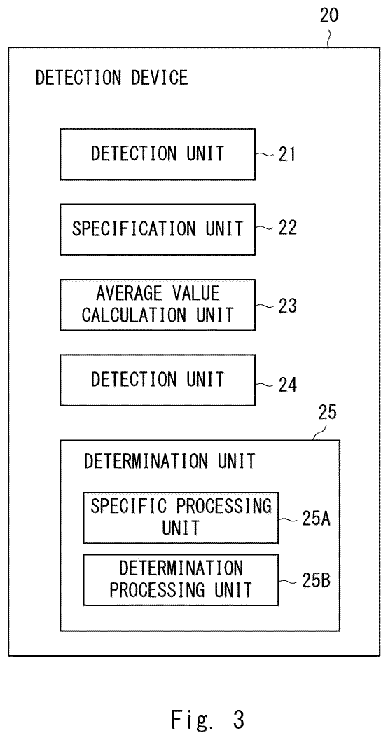

FIG. 3 is a block diagram illustrating an example of a detection device according to the second example embodiment. In FIG. 3, a detection device 20 includes a detection unit (first detection unit) 21, a specification unit 22, an average value calculation unit 23, a detection unit (second detection unit) 24, and a determination unit 25. The detection device 20 acquires a captured image similarly to the detection device 10 of the first example embodiment. This captured image is, for example, an article shelf image obtained by imaging an article shelf. The following description will be made assuming that the captured image is the article shelf image. The article shelf has a plurality of shelf stages.

Similarly to the detection unit 11 of the first example embodiment, the detection unit 21 applies the second model to the captured image in such a way as to detect the second image region in the captured image (that is, the article shelf image).

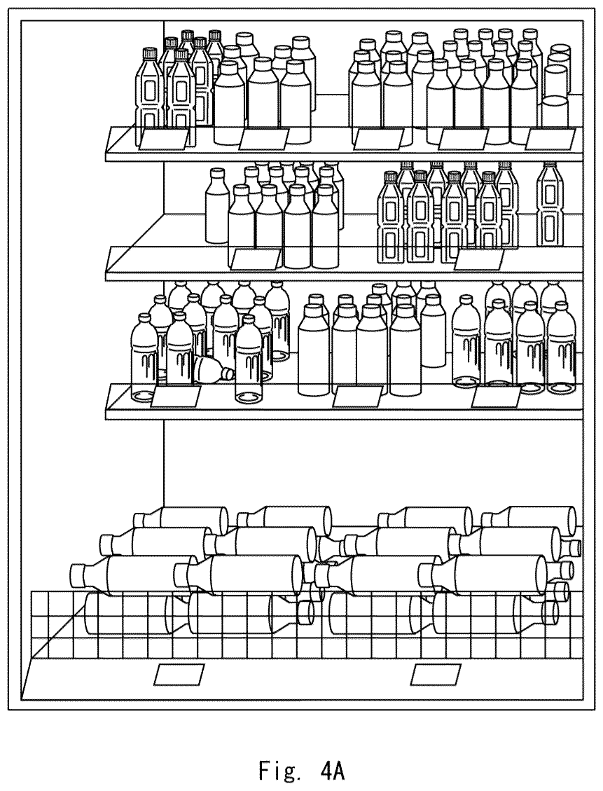

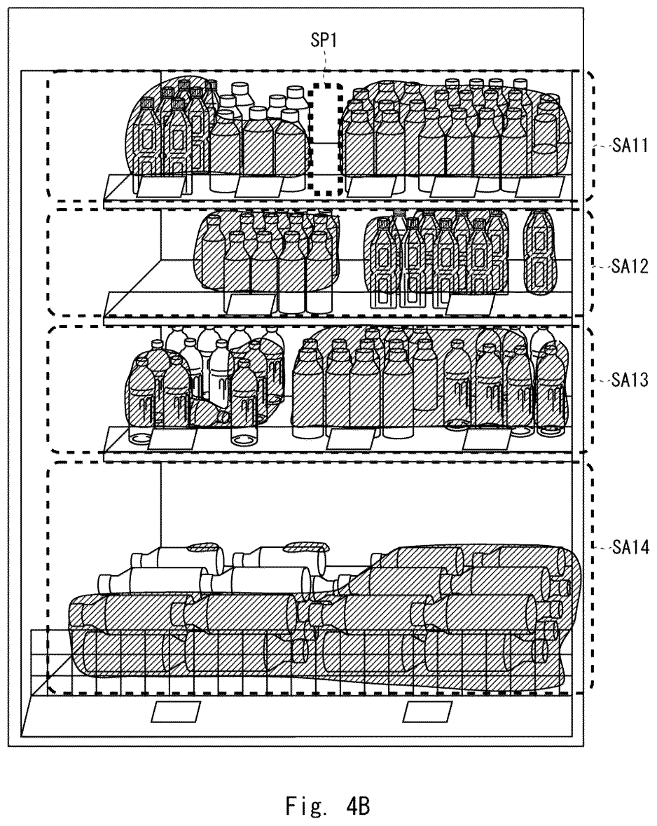

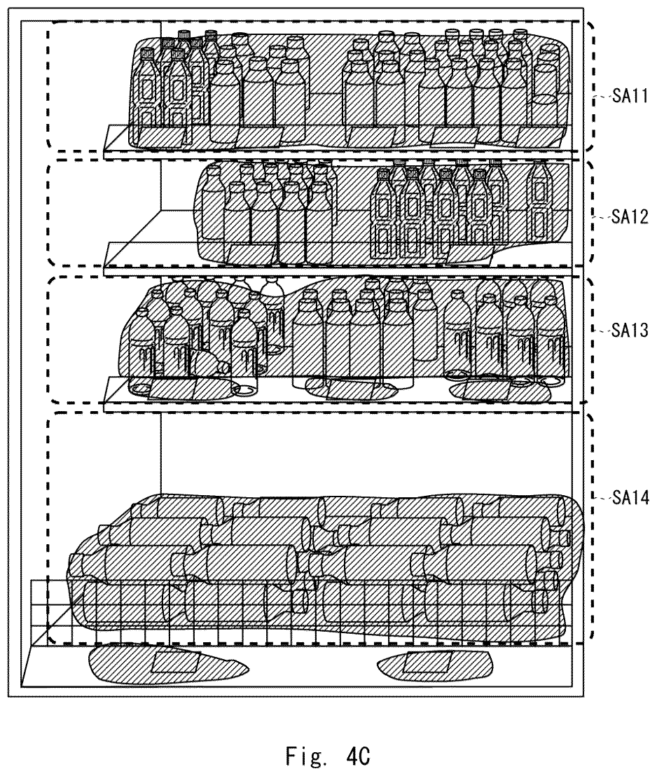

FIG. 4A is a diagram illustrating an example of the article shelf image. FIG. 4B is a diagram illustrating an example of the second image region.

FIG. 4A illustrates an article shelf image of a shelf on which plastic-bottled beverages are displayed. The article shelf shown in the article shelf image in FIG. 4A has four shelf stages. On three shelf stages from the top, plastic bottles as articles are arranged in a standing position. On the bottom shelf stage, plastic bottles are arranged in a horizontal position and in a stacked manner. On three shelf stages from the top, spaces above the plastic bottles are narrow, and on the bottom shelf stage, a space above the plastic bottles is wide. Therefore, most of the plastic bottles at the back are hidden by the plastic bottles on the front side in the image showing the three shelf stages from the top, and the plastic bottles backward are also shown in the image showing the bottom shelf stage.

FIG. 4B illustrates a result of applying the second model to the article shelf image of FIG. 4A. In FIG. 4B, a hatched region is relevant to the second image region.

As can be seen from FIG. 4B, the second model can accurately detect the article group image region relevant to a plastic bottle group in the image showing the three shelf stages from the top. As a result, the second model can accurately detect even an image region relevant to a narrow empty space sandwiched between two article group image regions.

On the other hand, as can be seen from FIG. 4B, in the image showing the bottom shelf stage, although the article group image region relevant to the plastic bottle group located on the front side can be detected, the article group image region relevant to the plastic bottle group located backward cannot be detected.

Returning to the description of FIG. 3, similarly to the specification unit 12 of the first example embodiment, the specification unit 22 specifies a plurality of “shelf-image regions” relevant to a plurality of shelf stages in the captured image.

For example, as can be seen from FIG. 4B, the lower line defining the second image region in the image of each shelf stage appears as a straight line substantially parallel to the shelf panel. That is, by specifying this straight line, it is possible to specify a line relevant to the surface of the plastic bottle in contact with the shelf panel.

Therefore, the specification unit 22 may specify the lower line defining the second image region in the image of each shelf stage, and specify an image region sandwiched between two adjacent lines as the “shelf-image region”.

Alternatively, for example, the specification unit 22 may directly specify the front image of the shelf panel by pattern matching or the like. The front image of the shelf panel can also be specified as a line relevant to the surface of the plastic bottle in contact with the shelf panel. The specification unit 22 may specify the image region sandwiched between two adjacent lines as the “shelf-image region”. Image regions SA11, SA12, SA13, and SA14 surrounded by frames in FIG. 4B are examples of the shelf-image regions.

The average value calculation unit 23 calculates an average value of the heights of the second image regions in the shelf-image regions, similarly to the average value calculation unit 13 of the first example embodiment. The height of the second image region is a length of the second image region relevant to the height direction of the article shelf.

Similarly to the determination unit 15 of the first example embodiment, the determination unit 25 determines, based on the heights of shelf-image regions and an average value of the height of the second image region in each shelf-image region, an image region to be processed by the detection unit 24 from among the plurality of shelf-image regions.

For example, as illustrated in FIG. 3, the determination unit 25 includes a specific processing unit 25A and a determination processing unit 25B.

The specific processing unit 25A specifies the length of each shelf-image region relevant to the height direction of the article shelf as the height (a) of each shelf-image region.

The determination processing unit 25B calculates the “reference value” for each shelf-image region by multiplying the height (α) of each specified shelf-image region by a predetermined ratio (for example, 0.6). Then, the determination processing unit 25B determines an image region to be processed by comparing the calculated “reference value” for each shelf-image region with the average value of the heights of the second image regions relevant to each shelf-image region. For example, the determination processing unit 25B determines a shelf-image region relevant to the second image region having an average value smaller than the “reference value” as an image region to be processed of the detection unit 24. In the example of FIG. 4B, the shelf-image region SA14 is determined by the determination processing unit 25B as the image region to be processed of the detection unit 24.

Similarly to the detection unit 14 of the first example embodiment, the detection unit 24 applies a first model to the image region to be processed, which has been determined by the determination unit 25, thereby detecting a first image region in the image region to be processed.

FIG. 4C is a diagram illustrating an example of the first image region. In FIG. 4C, a hatched region in a shelf-image region SA14 is relevant to the first image region. As can be seen from FIG. 4C, in the shelf-image region SA14 (that is, the image showing the bottom shelf stage), the model 1 can accurately detect not only the article group image region relevant to the plastic bottle group located on the front side but also the article group image region relevant to the plastic bottle group located backward. FIG. 4C also illustrates, for reference, results of applying a model 1 to the shelf-image regions SA11, SA12, and SA13. As can be seen from FIGS. 4B and 4C, there is a possibility that the model 1 detects, as a part of the article group image region, an image region relevant to a narrow empty space SP1 or the like sandwiched between two article group image regions.

### Third Example Embodiment

A third example embodiment relates to specification of an empty space.

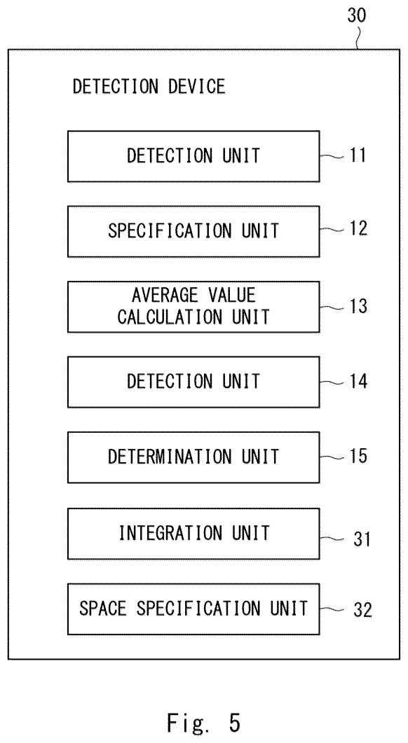

FIG. 5 is a block diagram illustrating an example of a detection device according to the third example embodiment. In FIG. 5, a detection device 30 includes a detection unit (first detection unit) 11, a specification unit 12, an average value calculation unit 13, a detection unit (second detection unit) 14, a determination unit 15, an integration unit 31, and a space specification unit 32.

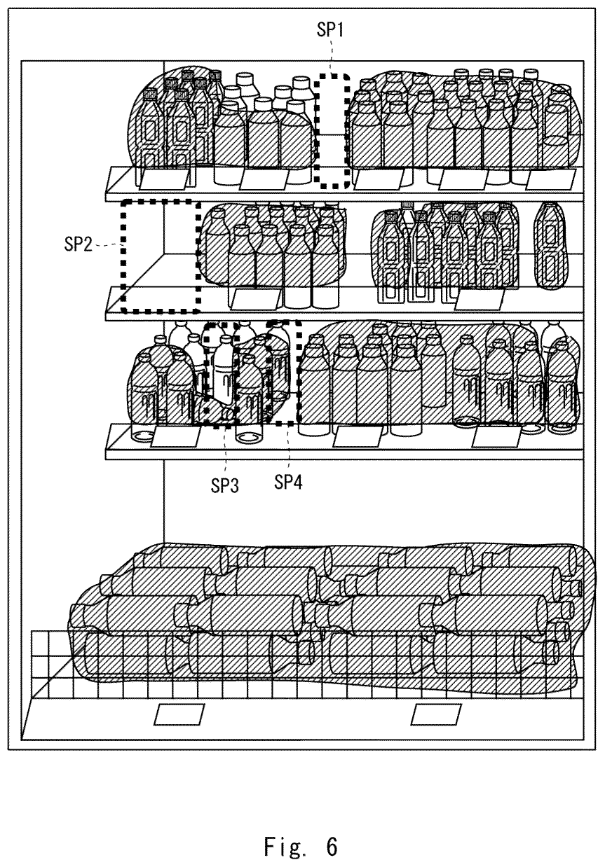

The integration unit 31 integrates the first image region in the image region to be processed detected by the detection unit 14 and the second image region in each shelf-image region other than the image region to be processed detected by the detection unit 11 to obtain an “integrated image”. For example, in the cases of FIGS. 4B and 4C, the second image regions in the shelf-image regions SA11, SA12, and SA13 detected by the second model and the first image region in the shelf-image region SA14 detected by the first model are integrated to form the “integrated image”. FIG. 6 is a diagram illustrating an example of the integrated image.

The space specification unit 32 specifies an empty space in which the articles are not arranged on each shelf stage based on the integrated image. For example, the space specification unit 32 may specify the empty space by subtracting the integrated image from the shelf-image region. In FIG. 6, for example, portions surrounded by rectangular frames (space SP1, SP2, SP3, and SP4) relevant to empty spaces.

As described above, since the detection device 30 according to the third example embodiment specifies the empty space based on the integrated image obtained by integrating the image regions obtained by applying the first model and the second model to the shelf-image region that is a detection target with high detection performance, it is possible to accurately specify the empty space.

Although the description has been made assuming that the integration unit 31 and the space specification unit 32 are applied to the detection device 10 of the first example embodiment, the present disclosure is not limited thereto. The integration unit 31 and the space specification unit 32 may be applied to the detection device 20 of the second example embodiment.

### Other Example Embodiments

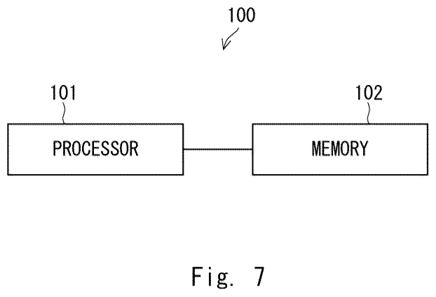

FIG. 7 is a diagram illustrating a hardware configuration example of a detection device. In FIG. 7, a detection device 100 includes a processor 101 and a memory 102. The processor 101 may be, for example, a microprocessor, a micro processing unit (MPU), or a central processing unit (CPU). The processor 101 may include a plurality of processors. The memory 102 is configured by a combination of a volatile memory and a nonvolatile memory. The memory 102 may include a storage located apart from the processor 101. In this case, the processor 101 may access the memory 102 via an I/O interface (not illustrated).

Each of the detection devices 10, 20, and 30 according to the first to third example embodiments can have the hardware configuration illustrated in FIG. 7.

The detection units 11 and 21, the specification units 12 and 22, the average value calculation units 13 and 23, the detection units 14 and 24, the determination units 15 and 25, the integration unit 31, and the space specification unit 32 of the detection devices 10, 20, and 30 according to the first to third example embodiments may be implemented by the processor 101 reading and executing a program stored in the memory 102. The program can be stored using various types of non-transitory computer-readable media and supplied to the detection devices 10, 20, and 30. Examples of the non-transitory computer-readable media include magnetic recording media (for example, flexible disks, magnetic tapes, or hard disk drives), and magneto-optical recording media (for example, magneto-optical disks). Other examples of the non-transitory computer-readable media include a read only memory (CD-ROM), a CD-R, and a CD-R/W. Other examples of the non-transitory computer-readable media include a semiconductor memory. Examples of the semiconductor memory include a mask ROM, a programmable ROM (PROM), an erasable PROM (EPROM), a flash ROM, and a random access memory (RAM). The program may be supplied to the detection devices 10, 20, and 30 by various types of transitory computer-readable media. Examples of transitory computer-readable media include electrical signals, optical signals, and electromagnetic waves. The transitory computer-readable media can supply the program to the detection devices 10, 20, and 30 via a wired communication path such as an electric wire or an optical fiber, or a wireless communication path.

Although the invention of the present application has been described above with reference to the example embodiments, the invention of the present application is not limited to the above. Various modifications that can be understood by those skilled in the art can be made to the configuration and details of the invention of the present application within the scope of the invention.

### REFERENCE SIGNS LIST

10 detection device
11 detection unit (first detection unit)
12 specification unit
13 average value calculation unit
14 detection unit (second detection unit)
20 detection device
21 detection unit (first detection unit)
22 specification unit
23 average value calculation unit
24 detection unit (second detection unit)
25 determination unit
25A specific processing unit
25B determination processing unit
30 detection device
31 integration unit
32 space specification unit

What is claimed is:

1. A detection device comprising:
at least one memory storing instructions, and
at least one processor configured to execute the instructions to perform processes, the processes comprising:
detecting a second image region in a captured image in which an article shelf is imaged by using a second model among a first model that identifies a first image region based on a space primarily occupied by an article group in a target image and the second model that identifies a second image region relevant to an image of an article group arranged on a front side in a target image;
specifying a plurality of shelf-image regions relevant to a plurality of shelf stages of the article shelf in the captured image;
calculating an average value of heights of the second image regions relevant to a height direction of the article shelf in each shelf-image region;
determining an image region to be processed from among the plurality of shelf-image regions based on the average value in each shelf-image region and a height of each shelf-image region; and
detecting the first image region in the image region to be processed by applying the first model to the image region to be processed.

2. The detection device according to claim 1, wherein the determining of the image region to be processed includes determining the shelf-image region relevant to the second image region having the average value less than a predetermined ratio of a height of the shelf-image region among the plurality of shelf-image regions as the image region to be processed.

3. The detection device according to claim 2, wherein
the determining of the image region to be processed includes:
specifying a length of each shelf-image region relevant to a height direction of the article shelf as a height of each shelf-image region; and
determining the image region to be processed by comparing a value obtained by multiplying a height of the specified shelf-image region by the predetermined ratio with an average value of heights of the second image regions relevant to each shelf-image region.

4. The detection device according to claim 1, wherein the specifying of a plurality of shelf-image regions includes specifying a plurality of lines relevant to surfaces of articles in contact with shelf panels of the article shelf in the second image region, and specifying the plurality of shelf-image regions by dividing the captured image with the plurality of lines.

5. The detection device according to claim 1, wherein the processes further comprises integrating the first image region in the image region to be processed and the second image region in each shelf-image region other than the image region to be processed to obtain an integrated image.

6. The detection device according to claim 5, wherein the processes further comprises specifying an empty space in which articles are not arranged on each shelf stage based on the integrated image.

7. A detection method comprising:
detecting a second image region in a captured image in which an article shelf is imaged by using a second model among a first model that identifies a first image region based on a space primarily occupied by an article group in a target image and the second model that identifies a second image region relevant to an image of an article group arranged on a front side in a target image;
specifying a plurality of shelf-image regions relevant to a plurality of shelf stages of the article shelf in the captured image;
calculating an average value of heights of the second image regions relevant to a height direction of the article shelf in each shelf-image region;
determining an image region to be processed from among the plurality of shelf-image regions based on the average value in each shelf-image region and a height of each shelf-image region; and
detecting the first image region in the image region to be processed by applying the first model to the image region to be processed.

8. The detection method according to claim 7, wherein the determining includes determining a shelf-image region relevant to the second image region having the average value less than a predetermined ratio of a height of the shelf-image region among the plurality of shelf-image regions as the image region to be processed.

9. A non-transitory computer-readable medium storing a program that causes a detection device to execute:
detecting a second image region in a captured image in which an article shelf is imaged by using a second model among a first model that identifies a first image region based on a space primarily occupied by an article group in a target image and the second model that identifies a second image region relevant to an image of an article group arranged on a front side in a target image;
specifying a plurality of shelf-image regions relevant to a plurality of shelf stages of the article shelf in the captured image;
calculating an average value of heights of the second image regions relevant to a height direction of the article shelf in each shelf-image region;
determining an image region to be processed from among the plurality of shelf-image regions based on the average value in each shelf-image region and a height of each shelf-image region; and
detecting the first image region in the image region to be processed by applying the first model to the image region to be processed.

10. The non-transitory computer-readable medium according to claim 9, wherein the determining includes determining a shelf-image region relevant to the second image region having the average value less than a predetermined ratio of a height of the shelf-image region among the plurality of shelf-image regions as the image region to be processed.
